(19) United States
(12) Patent Application Publication
(10) Pub. No.: US 2012/0076612 A1
(43) Pub. Date: Mar. 29, 2012

(54) HIGH STRENGTH ALPHA/BETA TITANIUM ALLOY FASTENERS AND FASTENER STOCK

(76) Inventor: David J. Bryan, (US)

(21) Appl. No.: 12/903,851

(22) Filed: Oct. 13, 2010

Related U.S. Application Data
(63) Continuation-in-part of application No. 12/888,699, filed on Sep. 23, 2010.

(51) Int. Cl. F16B 33/00; F16B 43/00; C22F 1/18; F16B 19/04; C22C 14/00; F16B 37/00; F16B 39/24

(52) U.S. Cl. 411/204; 411/378; 411/427; 411/501; 420/420; 148/671

(57) ABSTRACT

An article of manufacture selected from a titanium alloy fastener and a titanium alloy fastener stock including an alpha/beta titanium alloy comprising, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; titanium; and up to a total of 0.3 of other elements. In certain embodiments, article of manufacture has an ultimate tensile strength of at least 170 ksi (1,172 MPa) and a double shear strength of at least 103 ksi (710.2 MPa). A method of manufacturing a titanium alloy fastener and a titanium alloy fastener stock comprising the alpha/beta alloy is disclosed.

### CROSS-REFERENCE TO RELATED APPLICATIONS

The present application is a continuation-in-part application claiming priority under 35 U.S.C. §120 from co-pending U.S. patent application Ser. No. 12/888,699, filed on Sep. 23, 2010, and entitled “High Strength Alpha/Beta Titanium Alloy Fasteners and Fastener Stock”, the entire disclosure of which is incorporated by reference herein.

### BACKGROUND OF THE TECHNOLOGY

1. Field of the Technology

The present disclosure relates to mechanical fasteners and fastener stock, and in particular to fasteners and fastener stock comprising alpha/beta titanium alloys.

2. Description of the Background of the Technology

Titanium alloys typically exhibit a high strength-to-weight ratio, are corrosion resistant, and are resistant to creep at moderately high temperatures. For these reasons, titanium alloys are used in aerospace and aeronautic applications including, for example, landing gear members, engine frames, and mechanical fasteners.

Reducing the weight of an aircraft results in fuel savings, and thus there is a strong drive in the aerospace industry to reduce aircraft weight. Titanium and titanium alloys are attractive materials for achieving weight reduction in aircraft applications because of their high strength-to-weight ratio. Currently, titanium alloy fasteners are used in less demanding aerospace applications. In certain aerospace applications in which titanium alloys do not exhibit sufficient strength to meet the particular mechanical requirements of the application, heavier iron and nickel based alloy fasteners are used.

Most titanium alloy parts used in aerospace applications are made from Ti-6Al-4V alloy (ASTM Grade 5; UNS R56400; AMS 4965), which is an alpha/beta titanium alloy. Typical minimum specification for small diameter Ti-6Al-4V fastener stock, i.e., fastener stock having a diameter less than 0.5 inches (1.27 cm), are 170 ksi (1,172 MPa) ultimate tensile strength (UTS), as determined according to ASTM E8/E8M-09 (“Standard Test Methods for Tension Testing of Metallic Materials” ASTM International, 2009), and 103 ksi (710 MPa) double shear strength (DSS), as determined according to NASM 1312-13 (“Method 13-Double Shear”, Aerospace Industries Association—National Aerospace Standard (Metric), Feb. 1, 2003).

Iron and nickel based superalloys, such as, for example, A286 iron-base superalloy (UNS S66286), are representative of materials used in aerospace fastener applications having the next tier of strength. Typical specified minimum strengths for cold drawn and aged A286 alloy fasteners are 180 ksi (1,241 MPa) UTS and 108 ksi (744 MPa) DSS.

Alloy 718 nickel based superalloy (N07718) is a material used in aerospace fasteners that represents the uppermost tier of strength. Typical specification minimums for cold drawn and aged Alloy 718 superalloy fasteners are 220 ksi (1,517 MPa) UTS and 120 ksi (827 MPa) DSS.

In addition, two beta titanium alloys that currently are in use or are under consideration for use as high strength fastener materials exhibit minimum ultimate tensile strength of 180 ksi (1,241.1 MPa) and minimum DSS of 108 ksi (744.6 MPa). SPS Technologies, Jenkintown, Pa., offers a titanium alloy fastener fabricated from an optimized beta-titanium alloy that conforms to the chemistry of Ti-3Al-8V-6Cr-4Zr-4Mo titanium alloy (AMS 4958). The SPS bolts are available in diameters up to 1 inch (2.54 cm). Alcoa Fastening Systems (AFS) has developed a high-strength titanium fastener made from a titanium alloy that conforms to the nominal chemistry of Ti-5Al-5Mo-5V-3Cr-0.5Fe titanium alloy (also referred to as Ti-5553; UNS unassigned), a near beta-titanium alloy. The AFS Ti-5553 alloy fasteners reportedly exhibit tensile strength of 190 ksi (1,309 MPa), greater than 10% elongation, and minimum DSS of 113 ksi (779 MPa) for uncoated parts and 108 ksi (744 MPa) for coated parts.

Beta-titanium alloys generally include a high alloying content, which increases the cost of components and processing compared with alpha/beta titanium alloys. Beta-titanium alloys also generally have a higher density than alpha/beta titanium alloys. For example ATI 425® alpha/beta titanium alloy has a density of about 0.161 lbs/in³ (4.5 g/cm³), whereas the beta-titanium alloy Ti-3Al-8V-6Cr-4Zr-4Mo has a density of about 0.174 lbs/in³ (4.8 g/cm³), and the near beta-titanium alloy Ti-5Al-5Mo-5V-3Cr-0.5Fe has a density of about 0.168 lbs/in³ (4.7 g/cm³). Fasteners made from titanium alloys that are less dense may provide further weight savings for aerospace applications. In addition, the bimodal microstructure that is obtained, for example, in solution treated and aged alpha/beta titanium alloys may provide improved mechanical properties such as high cycle fatigue compared to beta-titanium alloys. Alpha/beta titanium alloys also have a higher beta transus temperature (T_{β}) than beta-titanium alloys. For example, the T_{β} of ATI 425® alpha/beta titanium alloy is about 1,800° F. (982.2° C.), whereas Ti-5Al-5Mo-5V-3Cr-0.5Fe beta titanium alloy has a T_{β} of about 1,500° F. (815.6° C.). The difference in T_{β} for the two forms of titanium alloys allows for a larger temperature window for thermomechanical processing and heat treatment in the alpha/beta phase field for alpha/beta titanium alloys.

Given the continuing need for reduced fuel consumption through aircraft weight reduction, a need exists for improved lightweight fasteners for aerospace applications. In particular, it would be advantageous to provide lightweight alpha/beta titanium alloy aerospace fasteners and fastener stock exhibiting higher strength than current generation aerospace fasteners fabricated from Ti-6Al-4V alpha/beta titanium alloy.

### SUMMARY

In a non-limiting embodiment according to the present disclosure, an article of manufacture selected from a titanium alloy fastener and a titanium alloy fastener stock includes an alpha/beta titanium alloy comprising, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; titanium; and up to a total of 0.3 of other elements. In a non-limiting embodiment, the alpha/beta titanium alloy fastener or fastener stock exhibits an ultimate tensile strength of at least 170 ksi (1,172 MPa) and a double shear strength of at least 103 ksi (710.2 MPa).

In an additional non-limiting embodiment according to the present disclosure, an article of manufacture selected from a titanium alloy fastener and a titanium alloy fastener stock comprises an alpha/beta titanium alloy consisting essentially of, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; up to a total of 0.3 of other elements; titanium; incidental impurities; and wherein the other elements consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005. In a non-limiting embodiment, the alpha/beta titanium alloy fastener or fastener stock exhibits an ultimate tensile strength of at least 170 ksi (1,172 MPa) and a double shear strength of at least 103 ksi (710.2 MPa).

In another non-limiting embodiment according to the present disclosure, a method for producing a titanium alloy fastener stock includes providing an alpha/beta titanium alloy comprising, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; titanium; and up to a total of 0.3 of other elements. The alpha/beta titanium alloy is hot rolled and, subsequently, is annealed at an annealing temperature in a range of 1,200° F. (648.9° C.) to 1,400° F. (760° C.) for an annealing time in a range of 1 hour to 2 hours. After annealing, the alpha/beta titanium alloy is air cooled, and then machined to predetermined dimensions. The alpha/beta titanium alloy is then solution treated at a solution treatment temperature in a range of 1,500° F. (815.6° C.) to 1,700° F. (926.7° C.) for a solution treating time in a range of 0.5 hours to 2 hours. After solution treatment, the alpha/beta titanium alloy is cooled at a cooling rate that is at least as fast as air cooling, and then aged at an aging treatment temperature in a range of 800° F. (426.7° C.) to 1,000° F. (537.8° C.) for an aging time in a range of 4 hours to 16 hours. Following aging, the titanium alloy is air cooled. In a non-limiting embodiment, an alpha/beta titanium alloy made according to the foregoing method embodiment exhibits an ultimate tensile strength of at least 170 ksi (1,172 MPa) and a double shear strength of at least 103 ksi (710.2 MPa).

### BRIEF DESCRIPTION OF THE DRAWINGS

The features and advantages of methods described herein may be better understood by reference to the accompanying drawings in which:

FIG. 1 is schematic representation of non-limiting embodiments of fasteners according to the present disclosure;

FIG. 2. is a flow diagram of a non-limiting embodiment of a method of producing fasteners and fastener stock according to the present disclosure;

FIG. 3 is a plot of ultimate tensile strength of fastener bar and wire stock made by non-limiting embodiments according to the present disclosure, comparing those properties with requirements for Ti-6Al-4V titanium alloy fastener bar and wire stock;

FIG. 4 is a plot of yield strength of fastener bar and wire stock made by non-limiting embodiments according to the present disclosure, comparing those properties with requirements for Ti-6Al-4V titanium alloy fastener bar and wire stock; and

FIG. 5 is a plot of percent elongation of fastener bar and wire stock made by non-limiting embodiments according to the present disclosure, comparing those properties with requirements for Ti-6Al-4V titanium alloy fastener bar and wire stock.

The reader will appreciate the foregoing details, as well as others, upon considering the following detailed description of certain non-limiting embodiments of methods according to the present disclosure.

### DETAILED DESCRIPTION OF CERTAIN NON-LIMITING EMBODIMENTS

In the present description of non-limiting embodiments, other than in the operating examples or where otherwise indicated, all numbers expressing quantities or characteristics are to be understood as being modified in all instances by the term “about”. Accordingly, unless indicated to the contrary, any numerical parameters set forth in the following description are approximations that may vary depending on the desired properties one seeks to obtain in the materials and by the methods according to the present disclosure. At the very least, and not as an attempt to limit the application of the doctrine of equivalents to the scope of the claims, each numerical parameter should at least be construed in light of the number of reported significant digits and by applying ordinary rounding techniques.

Any patent, publication, or other disclosure material that is said to be incorporated, in whole or in part, by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

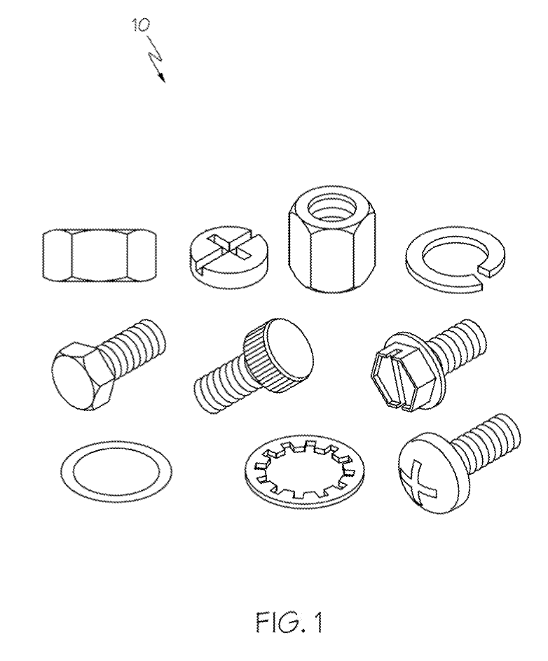

Referring now to FIG. 1, an aspect of this disclosure is directed to an article of manufacture selected from a titanium alloy fastener 10 and a titanium alloy fastener stock (not shown). In a non-limiting embodiment, the article includes an alpha/beta titanium alloy comprising, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; titanium; and up to a total of 0.3 of other elements. In non-limiting embodiments of this disclosure the other elements referred to in the alloy composition comprise or consist essentially of one or more of tin, zirconium, molybdenum, chromium, nickel, silicon, copper, niobium, tantalum, manganese, and cobalt, each having a maximum concentration of 0.1 weight percent as individual elements, and boron and yttrium, each having a maximum concentration of 0.005% as individual elements, with the sum total of all of the other elements not exceeding 0.3 weight percent. In a non-limiting embodiment, the alpha/beta titanium article of manufacture according to the present disclosure exhibits an ultimate tensile strength of at least 170 ksi (1,172 MPa) and a double shear strength (DSS) of at least 103 ksi (710.2 MPa) for fasteners having diameters in the range of 0.18 inches (4.57 mm) to 1.25 inches (31.8 mm). In a non-limiting embodiment of this disclosure, fasteners may have diameters as small as can be fabricated. In a non-limiting embodiment, fasteners according to the present disclosure exhibit a percent elongation of at least 10%.

In certain non-limiting embodiments, the elemental composition of an alpha/beta titanium alloy included in the fastener or fastener stock according to the present disclosure is encompassed by the alloy composition disclosed in U.S. Pat. No. 5,980,655 (“the '655 patent”), which is incorporated by reference herein in its entirety. The '655 patent discloses an alloy having the composition shown in the following Table 1.

TABLE 1

| Alloying Element | Percent by Weight |
|---|---|
| Aluminum | from about 2.9 to about 5.0 |
| Vanadium | from about 2.0 to about 3.0 |
| Iron | from about 0.4 to about 2.0 |
| Oxygen | greater than 0.2 to about 0.3 |
| Carbon | from about 0.005 to about 0.03 |
| Nitrogen | from about 0.001 to about 0.02 |
| Other elements | less than about 0.5 |

A commercial version of the alloy of the '655 patent is ATI 425® alloy, which is available from ATI Aerospace, a business of Allegheny Technologies Incorporated, Pittsburgh, Pa. The ultimate tensile strength of alloys having the elemental composition disclosed in the '655 patent ranges from about 130 to 133 ksi (896 to 917 MPa). However, the present inventor surprisingly discovered that the significantly narrower range of chemistry in the present disclosure results in alpha/beta titanium fasteners that may exhibit the significantly higher ultimate tensile strengths disclosed herein. In a non-limiting embodiment, the ultimate tensile strength of the fasteners disclosed herein, made from the alloy composition disclosed herein, was up to 22% greater than the UTS disclosed in the '655 patent. Without intending to be bound by any theory of operation, it is believed that the surprisingly high strength of fastener alloy compositions disclosed herein may have been at least in part a result of significantly increasing the aluminum and oxygen levels above minimum levels disclosed in the '655 patent, which may have increased the strength of the dominant alpha phase in the alpha/beta titanium alloy.

The inventor also surprisingly discovered that narrowing the allowable ranges of aluminum, vanadium, iron, oxygen, carbon, and nitrogen in the fastener alloy disclosed herein relative to the alloy disclosed in the '655 patent reduces the variability of the mechanical properties and the variability of the beta transus temperature of the fastener alloy disclosed herein. This reduced variability is important for process and microstructural optimization to achieve the superior mechanical properties disclosed herein.

In another non-limiting embodiment, a titanium alloy fastener and a titanium alloy fastener stock disclosed herein comprises a diameter of up to 0.75 inches (1.91 cm), and has an ultimate tensile strength of at least 180 ksi (1,241 MPa) and a double shear strength of at least 108 ksi (744.6 MPa). In a non-limiting embodiment, fasteners or fastener stock according to this disclosure have up to about 26% greater ultimate tensile strength than the ultimate tensile strength disclosed in the '655 patent.

Referring again to FIG. 1, according to another non-limiting aspect of this disclosure, an article of manufacture selected from a titanium alloy fastener 10 and a titanium alloy fastener stock (not shown) includes an alpha/beta titanium alloy consisting essentially of, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; no more than a total of 0.3 of other elements; with the remainder titanium; and incidental impurities. In non-limiting embodiments of this disclosure the other elements referred to in the alloy composition comprise or consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005, with the sum total of all of the other elements not exceeding 0.3 weight percent. In a non-limiting embodiment, the article of manufacture has an ultimate tensile strength of at least 170 ksi (1,172 MPa) and a double shear strength of at least 103 ksi (710.2 MPa).

In a non-limiting embodiment, a titanium fastener and a titanium alloy fastener stock according to the present disclosure comprises a diameter of up to 0.75 inches (1.91 cm), an ultimate tensile strength of at least 180 ksi (1,241 MPa), and a double shear strength of at least 108 ksi (744.6 MPa).

As used herein, the term “fastener” refers to a hardware device that mechanically joins or affixes two or more objects together. A fastener includes, but is not limited to, a bolt, a nut, a stud, a screw, a rivet, a washer, and a lock washer. As used herein, the phrase “fastener stock” refers to an article that is processed to form one or more fasteners from the article.

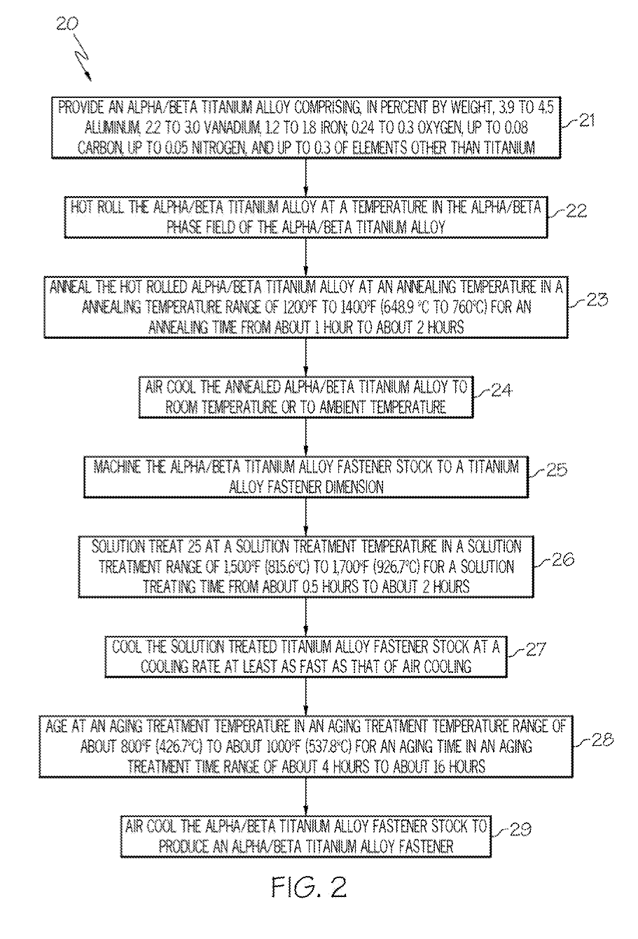

Referring to FIG. 2, a non-limiting aspect according of the present disclosure is a method 20 for producing a titanium alloy fastener or fastener stock. The method comprises providing 21 an alpha/beta titanium alloy comprising, in percent by weight: 3.9 to 4.5 aluminum; 2.2 to 3.0 vanadium; 1.2 to 1.8 iron; 0.24 to 0.3 oxygen; up to 0.08 carbon; up to 0.05 nitrogen; titanium; and up to a total of 0.3 of other elements. In non-limiting embodiments of this disclosure the other elements referred to in the alloy composition comprise or consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005, with the sum total of all of the other elements not exceeding 0.3 weight percent. The alpha/beta titanium alloy is hot rolled 22 at a temperature in the alpha/beta phase field of the alpha/beta titanium alloy. In a non-limiting embodiment, a hot rolling temperature is at least 50° F. (27.8° C.) below the beta transus temperature of the alpha/beta titanium alloy, but no more that 600° F. (333.3° C.) below the beta transus temperature of the alpha/beta titanium alloy.

After hot rolling 22, the alpha/beta titanium alloy optionally is cold drawn and annealed to reduce size without substantially changing the mechanical properties of the alpha/beta titanium alloy. In a non-limiting embodiment, cold drawing reduces the cross-sectional area of the titanium alloy workpiece by less than 10%. Prior to cold drawing, the alpha/beta titanium alloy may be coated with a solid lubricant, such as, but not limited to, molybdenum disulfide (MoS₂).

In a non-limiting embodiment, after hot rolling 22, the alpha/beta titanium alloy is annealed 23 and cooled 24 to provide an alpha/beta titanium alloy fastener stock. In a non-limiting embodiment, annealing 23 includes annealing the hot rolled alpha/beta titanium alloy at an annealing temperature in an annealing temperature range of 1,200° F. to 1,400° F. (649° C. to 760° C.). In another non-limiting embodiment, an annealing time ranges from about 1 hour to about 2 hours. In still another non-limiting embodiment, annealing 23 comprises annealing the hot rolled alpha/beta titanium alloy at about 1,275° F. (690.6° C.) for about one hour. In a non-limiting embodiment, after annealing 23, the annealed alpha/beta titanium alloy is cooled 24 to room temperature or to ambient temperature. In certain non-limiting embodiments, after annealing 23, the annealed alpha/beta titanium alloy is air cooled or water cooled to room temperature or to ambient temperature.

After annealing 23 and cooling 24, in a non-limiting embodiment, the alpha/beta titanium alloy fastener stock is machined 25 to a dimension useful for forming a fastener from the stock. Optionally, a coating may be applied to the alpha/beta titanium alloy fastener stock prior to machining. Conventional machining coatings are known to persons skilled in the art and need not be elaborated upon herein.

In a non-limiting embodiment, the machined titanium alloy fastener stock is solution treated 26 at a solution treatment temperature in a solution treatment range of 1,500° F. (815.6° C.) to 1,700° F. (926.7° C.) for a solution treating time in a range of 0.5 hours to 2 hours. In a specific non-limiting embodiment, the machined titanium alloy fastener stock is solution treated 26 at a solution treatment temperature of about 1610° F. (876.7° C.).

After solution treatment 26, the machined titanium alloy fastener stock is cooled 27. In non-limiting embodiments, cooling 27 may be carried out using, air cooling, water cooling, and/or water quenching, and may be referred to as “fast cooling”. Preferably, the cooling rate achieved during cooling 27 is as fast as air cooling. In a non-limiting embodiment, cooling 27 comprises a cooling rate of at least 1,000° F. (555.6° C.) per minute. In a non-limiting embodiment, cooling 27 comprises any cooling process known to a person skilled in the art that achieves the indicated cooling rate. Fast cooling 27 is used to preserve the microstructure obtained by solution treatment 26.

In a non-limiting embodiment, the solution treated 26 and fast cooled 27 titanium alloy fastener stock is aged 28 at an aging treatment temperature in an aging treatment temperature range of about 800° F. (426.7° C.) to about 1,000° F. (537.8° C.) for an aging time in an aging treatment time range of about 4 hours to about 16 hours. In a specific non-limiting embodiment, the solution treated 26 and fast cooled 27 titanium alloy fastener stock is aged 28 at 850° F. (454.4° C.) for 10 hours. In certain non-limiting embodiments, after aging 28, the alpha/beta titanium alloy fastener stock is air cooled 29 or fast cooled to produce an alpha/beta titanium alloy fastener as disclosed herein.

It has been determined that fastener stock manufactured according to this disclosure has higher mechanical properties compared with fastener stock fabricated from Ti-6-4 titanium alloy. Therefore, it is possible to use fasteners fabricated according to this disclosure in smaller dimensions to replace Ti-6-4 fasteners in the same applications. This leads to savings in weight, which is of value in aerospace applications. It also has been determined that in certain applications, fasteners fabricated according to this disclosure could replace steel alloy fasteners having the same dimensions and result in a weight savings of value for aerospace applications.

The examples that follow are intended to further describe certain non-limiting embodiments, without restricting the scope of the present invention. Persons having ordinary skill in the art will appreciate that variations of the following examples are possible within the scope of the invention, which is defined solely by the claims.

### Example 1

An ingot was produced from compacts made from raw materials using double vacuum arc remelt (VAR) technology. Samples were taken from the ingot for chemical analysis, and the measured average chemistry of the ingot is provided in Table 2. The beta transus temperature of the alloy was determined to be 1,785° F. (973.9° C.).

TABLE 2

| Al | V | Fe | O | N | C | Remainder |
|---|---|---|---|---|---|---|
| 4.06 | 2.52 | 1.71 | 0.284 | 0.008 | 0.017 | Ti and |
| | | | | | | incidental |
| | | | | | | impurities |

### Example 2

Titanium alloy ingot from several heats having chemical compositions according to this disclosure were hot rolled at a hot rolling temperature of about 1,600° F. (871.1° C.). The hot rolled material was annealed at 1,275° F. (690.6° C.) for 1 hour and air cooled. The annealed material was machined into fastener stock bars and wires having various diameters from about 0.25 inches (6.35 mm) to about 3.5 inches (88.9 mm). The fastener stock bars and wires were solution treated at about 1,610° F. (876.7° C.) for about 1 hour and water quenched. After solution treatment and water quenching, the fastener stock bars and wires were aged at about 850° F. (454.4° C.) for about 10 hours and air cooled.

### Example 3

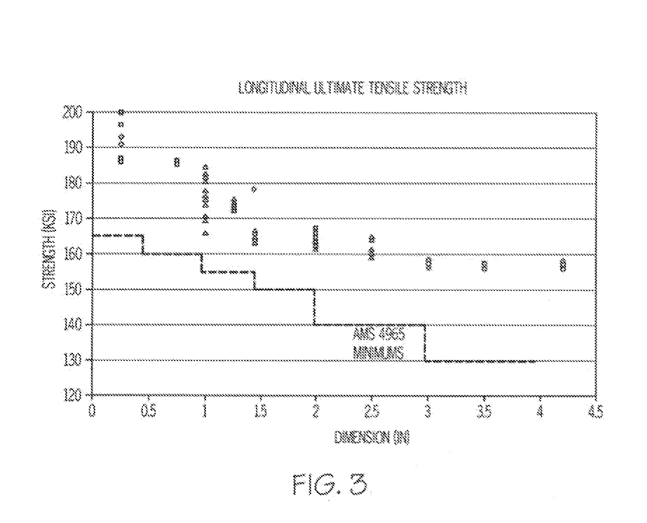

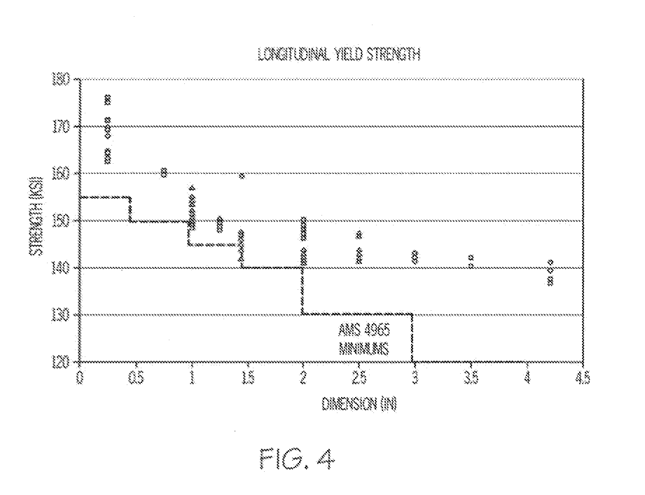

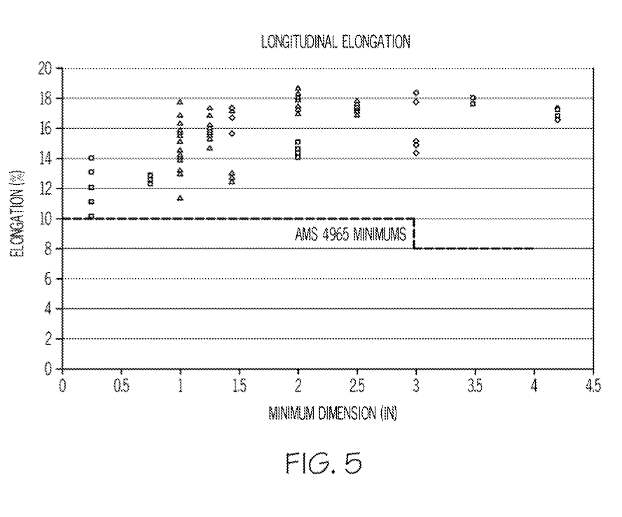

The fastener stock bars and wires from Example 2 were tensile tested at room temperature. The ultimate tensile strengths of the fastener stock bars and wires are presented graphically in FIG. 3. The yield strengths of the fastener stock bars and wires are presented graphically in FIG. 4, and the percent elongations of fastener stock bars and wires are presented graphically in FIG. 5. The minimum ultimate tensile strength, yield strength, and percent elongation required for solution treated and aged Ti-6Al-4V alloy in aerospace fastener applications (AMS 4965) are also illustrated in FIGS. 3-5, respectively. It is seen from FIG. 3 that ultimate tensile strengths measured for the fastener stock bar and wire manufactured according to this disclosure exceeded the illustrated Ti-6Al-4V alloy specifications by the significant amount of approximately 20 ksi (138 MPa) in all measured diameter sizes. Further, it is seen from FIG. 5 that fastener stock having chemical compositions according to this disclosure exhibited percent elongations in the range of at least 10 percent to about 19 percent.

### Example 4

Fastener stock having a diameter of about 0.25 inches (6.35 mm), having the chemical composition from Example 1, and solution treated and aged as in Example 2 was tensile tested. The results of the tensile tests are listed in Table 3.

TABLE 3

| Ultimate | Yield | | | Double Shear |
|---|---|---|---|---|
| Tensile | Strength | Percent | Reduction in | Strength |
| Strength (ksi) | (ksi) | Elongation | Area | (ksi) |
| 199.9 | 175.1 | 13.0 | 45 | 123.3 |
| 199.9 | 176.2 | 13.0 | 44 | 120.0 |
| 196.3 | 169.4 | 10.0 | 39 | 117.4 |
| 196.9 | 171.4 | 11.0 | 39 | 117.2 |

The ultimate tensile strengths ranged from about 196 ksi to about 200 ksi (1351 MPa to 1379 MPa), which is higher than the minimum requirements for Ti-6Al-4V fastener stock of 170 ksi (1,172 MPa) UTS and 103 ksi (710 MPa) DSS. It is also observed that the properties agree with the accepted empirical relationship that DSS=0.6×UTS.

### Example 5

Fastener stock having a diameter of about 0.75 inches (1.91 cm), having a chemistry from Example 1, and heat treated according to Example 2 was tensile tested. The results of the tensile tests are listed in Table 4.

TABLE 4

| Diameter | Ultimate Tensile | Yield Strength | Percent |
|---|---|---|---|
| (inch) | Strength (ksi) | (ksi) | Elongation |
| 0.75 | 185.9 | 160.3 | 12.3 |
| 0.75 | 185.8 | 160.1 | 12.8 |
| 0.75 | 185.4 | 159.7 | 12.9 |
| 0.75 | 186 | 159.5 | 12.7 |
| 0.75 | 186.1 | 160.3 | 12.4 |
| 0.75 | 186.1 | 160 | 12.4 |
| 0.75 | 186.3 | 160.6 | 12.4 |
| 0.75 | 186.1 | 160.3 | 12.8 |
| Average | 186.0 | 160.1 | 12.6 |
| STD | 0.3 | 0.4 | 0.2 |

The average ultimate tensile strength of the 0.75 inch (1.91 cm) fastener stock bars was 186 ksi (1,282 MPa), which satisfies the minimum specification for fasteners fabricated from A286 iron-base superalloy. Based upon the accepted empirical relationship between DSS and UTS presented hereinabove, the 0.75 inch (1.91 cm) bars are expected to also meet the 108 ksi (744 MPa) DSS requirement for fasteners fabricated from A286 iron-base superalloy.

### Example 6

Ingot having the chemical composition as in Example 1 is hot rolled, annealed, and machined as in Example 2 to form a fastener stock having a diameter of about 0.75 inches (1.91 cm). The fastener stock is computer numerical control machined into a fastener having a shape of a stud. The stud is solution treated and aged as in Example 2 to form a non-limiting embodiment of a fastener of this disclosure.

### Example 7

Ingot having the chemical composition as in Example 1 is hot rolled, annealed, and machined as in Example 2 to form a fastener stock having a diameter of about 1 inch (2.54 cm). The fastener stock is roll threaded and cut into pieces having lengths of about 2 inches (5.08 cm). The pieces are cold forged to form hex head bolts. The hex head bolts are solution treated and aged as in Example 2 to form a non-limiting embodiment of a fastener according to this disclosure.

### Example 7

Ingot having the chemical composition as in Example 1 is hot rolled, annealed, and machined as in Example 2 to form a fastener stock having a diameter of about 1 inch (2.54 cm). The center of the fastener stock is machined to provide a 0.5 inch (1.27 cm) diameter hole. The fastener stock is then cut into pieces having a thickness of 0.125 inches (0.318 cm). The fastener stock is solution treated and aged as in Example 2 to form a non-limiting embodiment of a fastener in the form of a washer according to this disclosure.

The present disclosure has been written with reference to various exemplary, illustrative, and non-limiting embodiments. However, it will be recognized by persons having ordinary skill in the art that various substitutions, modifications, or combinations of any of the disclosed embodiments (or portions thereof) may be made without departing from the scope of the invention as defined solely by the claims. Thus, it is contemplated and understood that the present disclosure embraces additional embodiments not expressly set forth herein. Such embodiments may be obtained, for example, by combining and/or modifying any of the disclosed steps, ingredients, constituents, components, elements, features, aspects, and the like, of the embodiments described herein. Thus, this disclosure is not limited by the description of the various exemplary, illustrative, and non-limiting embodiments, but rather solely by the claims. In this manner, it will be understood that the claims may be amended during prosecution of the present patent application to add features to the claimed invention as variously described herein.

1. An article of manufacture selected from a titanium alloy fastener and a titanium alloy fastener stock, the article of manufacture including an alpha/beta titanium alloy comprising, in percent by weight:
3.9 to 4.5 aluminum;
2.2 to 3.0 vanadium;
1.2 to 1.8 iron;
0.24 to 0.3 oxygen;
up to 0.08 carbon;
up to 0.05 nitrogen;
titanium; and
up to a total of 0.3 of other elements;
wherein the article of manufacture has an ultimate tensile strength of at least 170 ksi (1,172 MPa) and a double shear strength of at least 103 ksi (710.2 MPa).

2. The article of manufacture of claim 1, wherein the article of manufacture comprises a diameter of up to 0.75 inches (1.91 cm), and has an ultimate tensile strength of at least 180 ksi (1,241 MPa) and a double shear strength of at least 108 ksi (744.6 MPa).

3. The article of manufacture of claim 1, wherein the other elements consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005.

4. The article of manufacture according to claim 1, wherein the fastener comprises one of a bolt, a nut, a stud, a screw, a washer, a lock washer, and a rivet.

5. An article of manufacture selected from a titanium alloy fastener and a titanium alloy fastener stock, the article of manufacture including an alpha/beta titanium alloy consisting essentially of, in percent by weight:
3.9 to 4.5 aluminum;
2.2 to 3.0 vanadium;
1.2 to 1.8 iron;
0.24 to 0.3 oxygen;
up to 0.08 carbon;
up to 0.05 nitrogen;
no more than a total of 0.3 of other elements;
titanium; and
incidental impurities;
wherein the other elements consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005; and
wherein the article of manufacture has an ultimate tensile strength of at least 170 ksi (1,172 MPa) and a double shear strength of at least 103 ksi (710.2 MPa).

6. The article of manufacture of claim 5, wherein the article of manufacture comprises a diameter of up to 0.75 inches (1.91 cm), and has an ultimate tensile strength of at least 180 ksi (1,241 MPa) and a double shear strength of at least 108 ksi (744.6 MPa).

7. The article of manufacture according to claim 5, wherein the fastener comprises one of a bolt, a nut, a stud, a screw, a washer, a lock washer, and a rivet.

8. A method for producing a titanium alloy fastener stock, the method comprising:
providing an alpha/beta titanium alloy comprising, in percent by weight:
3.9 to 4.5 aluminum;
2.2 to 3.0 vanadium;
1.2 to 1.8 iron;
0.24 to 0.3 oxygen;
up to 0.08 carbon;
up to 0.05 nitrogen;
titanium; and
up to a total of 0.3 of other elements;
hot rolling the titanium alloy in an alpha/beta phase of the titanium alloy;
annealing the titanium alloy at an annealing temperature in a range of 1,200° F. (648.9° C.) to 1,400° F. (760° C.) for an annealing time in a range of 1 hour to 2 hours;
air cooling the titanium alloy;
machining the titanium alloy to a predetermined dimension;
solution treating the titanium alloy in a solution treatment range of 1,500° F. (815.6° C.) to 1,700° F. (926.7° C.) for a solution treating time in a range of 0.5 hours to 2 hours;
cooling the titanium alloy at a cooling rate that is at least equivalent to air cooling,
aging the titanium alloy at an aging treatment temperature in a range of 800° F. (426.7° C.) to 1,000° F. (537.8° C.) for an aging time in a range of 4 hours to 16 hours; and
air cooling the titanium alloy.

9. The method of claim 8, wherein the other elements of the alpha/beta titanium alloy consist essentially of one or more of tin, zirconium, molybdenum, chromium, nickel, silicon, copper, niobium, tantalum, manganese, and cobalt, wherein the weight percent of each such element is 0.1 or less, and boron and yttrium, wherein the weight percent of each such element is less than 0.005.

10. The method of claim 8, wherein the hot rolling is conducted at a temperature in the range of 50° F. (27.8° C.) below a beta transus temperature of the titanium alloy to 600° F. (333.3° C.) below the beta transus temperature of the titanium alloy.

11. The method of claim 8, further comprising after hot rolling and before annealing the titanium alloy, cold drawing the titanium alloy to a reduction in cross-sectional area less than 10% and annealing.

12. The method of claim 11, further comprising coating the titanium alloy with a solid lubricant before cold drawing.

13. The method of claim 12, wherein the solid lubricant is molybdenum disulfide.

14. The method of claim 8, wherein the annealing temperature is 1,275° F. (690.6° C.) and the annealing time is 1 hour.

15. The method of claim 8, wherein the titanium alloy is coated prior to machining the titanium alloy.

16. The method of claim 8, wherein cooling after the solution treating step comprises one of air cooling, water cooling, and water quenching.

17. The method of claim 8, wherein the solution treatment temperature is 1,610° F. (876.7° C.) and cooling the titanium alloy comprises water quenching.

18. The method of claim 8, wherein the aging the titanium alloy comprises aging at 850° F. (454.4° C.) for 10 hours.
